(19) United States
(12) Patent Application Publication
(10) Pub. No.: US 2003/0063187 A1
(43) Pub. Date: Apr. 3, 2003

(54) Computerized video imaging device

(76) Inventors: Frank Pagano, Staten Island, NY (US); Rosemarie Pagano, Staten Island, NY (US)

Correspondence Address: Michael I. Kroll, 171 Stillwell Lane, Syosset, NY, 11791, US

(21) Appl. No.: 09/968,583

(22) Filed: Oct. 1, 2001

(51) Int. Cl. H04N 7/18

(52) U.S. Cl. 348/61

(57) ABSTRACT

A computerized video imaging device for recording an image of all sides of a user. The device includes a video camera for capturing an image of the user, a recording device for recording said image captured by said video camera, a monitor for displaying the captured image and a processor for processing and enhancing the captured image by adding an image of a pair of glasses to the image of the user whereby the altered image is recorded by the recording device and displayed on the monitor whereby the user is able to view themselves in the monitor with a particular style of glasses. A motor is connected to rotate the camera to capture an image of the user at different angles. The monitor includes a touch screen and the processor controls display of a plurality of icons on the touch screen for controlling operation of the device by contacting desired ones of said plurality of icons. The recording device includes at least one of a floppy disk drive, a CD read/write drive and a video reproducing means. A memory unit stores data representative of a plurality of images of different glasses and contact lenses for use by the processor in altering the image. The plurality of icons allow the user to change a style, color, shape and size of glasses added by the processor. A printer is connected to the processor for generating a hard copy of an image enhanced by the processor.

### BACKGROUND OF THE INVENTION

1. Field of the Invention

The present invention related generally to video devices and, more specifically, to a device able to record an image showing all sides of a persons head and enhance the recorded image by adding computer generated accessories such as glasses to the proper position on the image thereby allowing the person to view themselves with the accessory and determine if the accessory suits them.

2. Description of the Prior Art

Numerous types of video recording and enhancing devices have been provided in the prior art. For example U.S. Pat. Nos. 5,826,122; 5,897,220; 5,905,526 and 5,950,031 all are illustrative of such prior art. While these units may be suitable for the particular purpose to which they address, they would not be as suitable for the purposes of the present invention as heretofore described.

A method for transmitting images to a remote location, including capturing an image from a network, local or global, displaying the image on a screen of a computer terminal and photographing the image as displayed on the screen, preferably while exposing a film for a duration longer than a plurality of the image on the screen.

The present teaches a computerized automatic photography booth for generating a synthesized sketch and a method therefor. The initial images to be converted may be real-time images taken on sight and/or stored images previously programmed into the memory of the computer. The computer maps out the essential characteristics of each image and converts the image into a sketch. Optionally, a background sketch is also programmed so as to form a composite.

An image signal sensing device electronically develops an image formed thereon. A light source illuminates an electro-developing recording medium. A line sensor associated with a scanner optical system is disposed on an imaging plane on which an image is formed. The electro-developing recording medium is supported by a recording medium holder that is movably connected to a feeding mechanism. The electro-developing recording medium is positioned between the light source and the scanner optical system. The electro-developing recording medium is moved by the feeding mechanism so that the image formed on the electro-developing medium is read by the line sensor.

A camera is presented which includes a first image taking portion for taking a picture of a subject as a digital image to be stored in a first memory and a second image taking portion for taking a picture of a subject as an image on a film. The camera further includes a controller for selectively performing one of first, second and third operations, in the first operation the first image taking portion is actuated independently of the second image taking portion to take a picture, in the second operation the second image taking portion is actuated independently of the first image taking portion to take a picture, and in the third operation both the first and second image taking portions are simultaneously actuated to take a picture of a common subject. The camera further includes a second memory for storing information about which of the first, second and third operations has been performed for which picture taken, and an indicating device for visually indicating the information.

### SUMMARY OF THE PRESENT INVENTION

The present invention relates generally to video devices and, more specifically, to a device able to record an image showing all sides of a persons head and enhance the recorded image by adding computer generated accessories such as glasses to the proper position on the image thereby allowing the person to view themselves with the accessory and determine if the accessory suits them.

A primary object of the present invention is to provide a computerized video imaging device that will overcome the shortcomings of prior art devices.

Another object of the present invention is to provide a computerized video imaging device which is able to record an image of all sides of a persons head on a recording medium.

A further object of the present invention is to provide a computerized video imaging device which is able to enhance the image by adding computer generated accessories such as glasses to a proper position on the image thereby providing the user with a depiction of how they look wearing glasses.

A yet further object of the present invention is to provide a computerized video imaging device able to alter the frames and lens sizes of the glasses to thereby allow a user to determine what size, shape and style glasses best suit them.

A yet further object of the present invention is to provide a computerized video imaging device able to alter the color of the glasses thereby allowing a user to determine which color glasses best suits them.

Another object of the present invention is to provide a computerized video imaging device that is simple and easy to use.

A still further object of the present invention is to provide a computerized video imaging device that is economical in cost to manufacture.

Additional objects of the present invention will appear as the description proceeds.

A computerized video imaging device for recording an image of all sides of a user is disclosed by the present invention. The device includes a video camera for capturing an image of the user, a recording device for recording said image captured by said video camera, a monitor for displaying the captured image and a processor for processing and enhancing the captured image by adding an image of a pair of glasses to the image of the user whereby the altered image is recorded by the recording device and displayed on the monitor whereby the user is able to view themselves in the monitor with a particular style of glasses. A motor is connected to rotate the camera to capture an image of the user at different angles. The monitor includes a touch screen and the processor controls display of a plurality of icons on the touch screen for controlling operation of the device by contacting desired ones of said plurality of icons. The recording device includes at least one of a floppy disk drive, a CD read/write drive and a video reproducing means. A memory unit stores data representative of a plurality of images of different glasses and contact lenses for use by the processor in altering the image. The plurality of icons allow the user to change a style, color, shape and size of glassed added by processor. A printer is connected to the processor for generating a hard copy of an image enhanced by the processor.

To the accomplishment of the above related objects, this invention may be embodied in the form illustrated in the accompanying drawings, attention being called to the fact, however, that the drawings are illustrative only, and that changes may be made in the specific construction illustrated within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of a user viewing their image in the computerized video imaging device of the present invention;

FIG. 2 is a front perspective view of the computerized video imaging device of the present invention showing different recording medium on which the image may be stored;

FIG. 3 is a perspective view of a person viewing hard copies of images produced by the computerized video imaging device of the present invention to view different sides of the head of the user;

FIG. 4a is a front view of an image produced by the computerized video imaging device of the present invention showing the user wearing glasses having a rounded shape at a bottom side thereof;

FIG. 4b is a front view of an image produced by the computerized video imaging device of the present invention showing the user wearing glasses having a rectangular shape;

FIG. 4c is a front view of an image produced by the computerized video imaging device of the present invention showing the user wearing glasses having a circular shape;

FIG. 4d is a front view of an image produced by the computerized video imaging device of the present invention showing the user wearing glasses having an oval shape;

FIG. 5a is a front view of an image produced by the computerized video imaging device of the present invention showing the user wearing blue colored contact lenses;

FIG. 5b is a front view of an image produced by the computerized video imaging device of the present invention showing the user wearing green colored contact lenses;

FIG. 5c is a front view of an image produced by the computerized video imaging device of the present invention showing the user wearing violet colored contact lenses;

FIG. 5d is a front view of an image produced by the computerized video imaging device of the present invention showing the user wearing contact lenses having a star pattern thereon; and

FIG. 6 is a block diagram of the computerized video imaging device of the present invention.

### DESCRIPTION OF THE REFERENCED NUMERALS

Turning now descriptively to the drawings, in which similar reference characters denote similar elements throughout the several views, the Figures illustrate the computerized video imaging device of the present invention. With regard to the reference numerals used, the following numbering is used throughout the various drawing figures.

10 computerized video imaging device of the present invention

12 camera

14 video monitor

16 motor

18 arrows indicating pivoting movement of camera

20 lens

22 touch screen

24 menu items

26 user

28 slot for receiving hard copy prints of images

30 hard copy

32 slot for inserting and removing floppy disk

34 slot for inserting and removing compact disks

36 slot for inserting and removing video tapes

38 image displayed on video monitor

40 glasses

42 icon for freezing the image

43 floppy disk

44 icon for saving the image on a floppy disk

46 icon for changing the style of frame inserted by the device

48 icon for changing the color of the lenses inserted by the device

50 icon to change the tint of the lenses

52 icon for activating printing a hard copy of the image being displayed

54 icon for saving the image to a CD

56 icon for saving the image to a video tape

58 compact disk

60 video tape

62 video monitor

64 video cassette recorder

66 image reproduced by video cassette recorder

68 hard copy of image produced by computerized video imaging device

70 processor

72 memory

74 power supply

76 floppy drive

78 CD ROM

80 video reproducing device

82 printer

### DETAILED DESCRIPTION OF THE PREFERRED EMBODIMENT

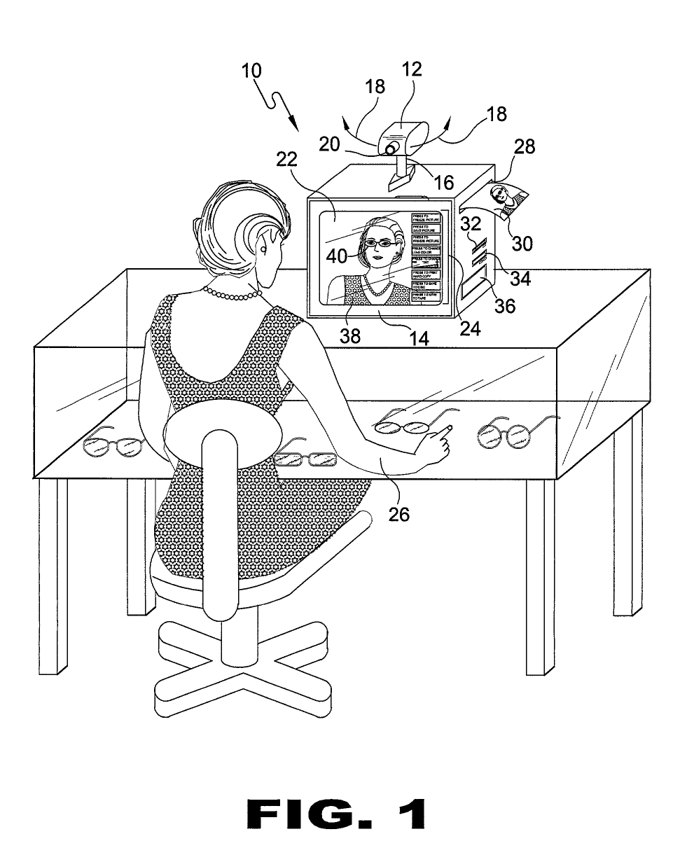

Turning now descriptively to the drawings, in which similar reference characters denote similar elements throughout the several views, FIGS. 1 through 6 illustrate the computerized video imaging device of the present invention indicated generally by the numeral 10.

The computerized video imaging device 10 is shown in FIG. 1. As can be seen from this figure, the computerized video imaging device 10 includes a camera 12 and a video monitor 14 on which the camera 12 is positioned. The camera 12 is connected to a motor 16 for rotating the camera 12 and thereby allowing the camera 12 to capture a panoramic image. Rotation of the camera 12 is indicated by the arrows labeled with the numeral 18. Positioned on the camera 12 is a lens 20. The direction in which the lens 20 faces to capture an image is dependent upon the rotational movement of the camera 12.

The video monitor 14 includes a touch screen 22. Displayed on the touch screen 22 is a list of menu items 24 which control the operation of the computerized video imaging device 10. The menu items 24 allow a user 26 to control operation of the lens 20, movement of the camera 12, recording of an image captured by the lens 22, replay of a recording medium on which the captured image is stored, altering the computer enhancements of the captured image and production of a printed hard copy of an image recorded by the computerized video imaging device 10. Positioned on a side of the video monitor 14 is a slot 28 through which a sheet 30 on which a printed image passes. The computerized video imaging device 10 also includes a disk drive, CD-ROM drive and a video recording device for recording captured images onto a recording medium. A slot 32 is provided on a side of the video monitor 14 for insertion and removal of a diskette from the disk drive. A slot 34 is provided on a side of the video monitor 14 for insertion and removal of a compact disk from the CD-ROM drive. A slot 36 is provided on a side of the video monitor 14 for insertion and removal of a video tape from the video recording device.

When the user 26 is positioned in front of the computerized video imaging device 10 the camera 12 is activated to capture an image in front of the lens 20 by touching the appropriate icon in the menu list 24 on the screen 20. The captured image 38 is displayed on the video monitor 14. This image 38 is preferably of the user 26 and based upon commands input by the user via the touch screen 22, the computerized video imaging device 10 electronically alters the image 38 by inserting glasses 40 onto the image of the face of the user 26. The user 26 is able to change the color, frame, style and size of the glasses 40 inserted by the computerized video imaging device 10 to view appearances in different types of glasses 40 by touching the appropriate menu item 24.

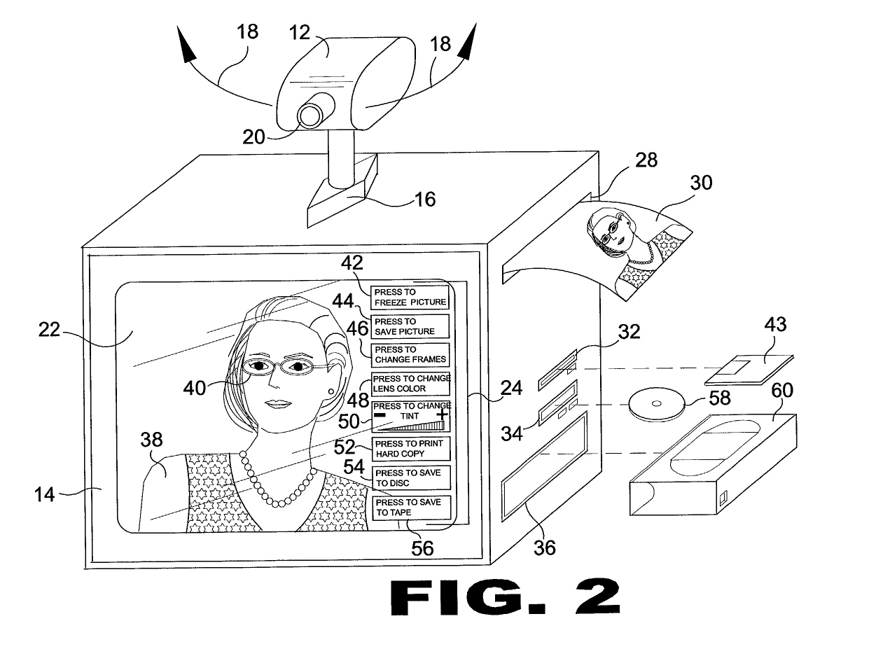

A front perspective view of the computerized video imaging device 10 is shown in FIG. 2. From this view, the camera 12 is shown rotationally positioned atop the video monitor 14. The screen 22 is displaying an image 38 of the user as captured by the lens 20. The computerized video imaging device 10 is altering the image 38 by inserting a pair of glasses 40 therein. To one side of the image 38 are a plurality of menu items 24 for controlling operation of the computerized video imaging device 10. The menu items 24 are activated by touching the screen 22 at the position of the desired command. The menu items 24 on the touch screen 22 include an icon 42 for freezing the image on the screen 22, an icon 44 for saving the image on a floppy disk 43, an icon 46 to change the style of frame being inserted by the computerized video imaging device 10, an icon 48 to change the color of the frame being inserted by the computerized video imaging device 10, an icon 50 to change the tint of the lenses, an icon 52 for activating printing of a hard copy 30 of the image being displayed, an icon 54 for saving the image to a CD 58 and an icon 56 for saving the image to a video tape 60.

On a side of the video monitor is the slot 32 for receiving the floppy disk 43. Slot 34 is provided for inserting and removing the compact disk 58 from the CD-ROM and slot 36 is provided on the side of the video monitor 14 for inserting and removing a video tape from the video recording device. Slot 28 provides an output for hard copy images 30 to be provided to a user from the video monitor 14.

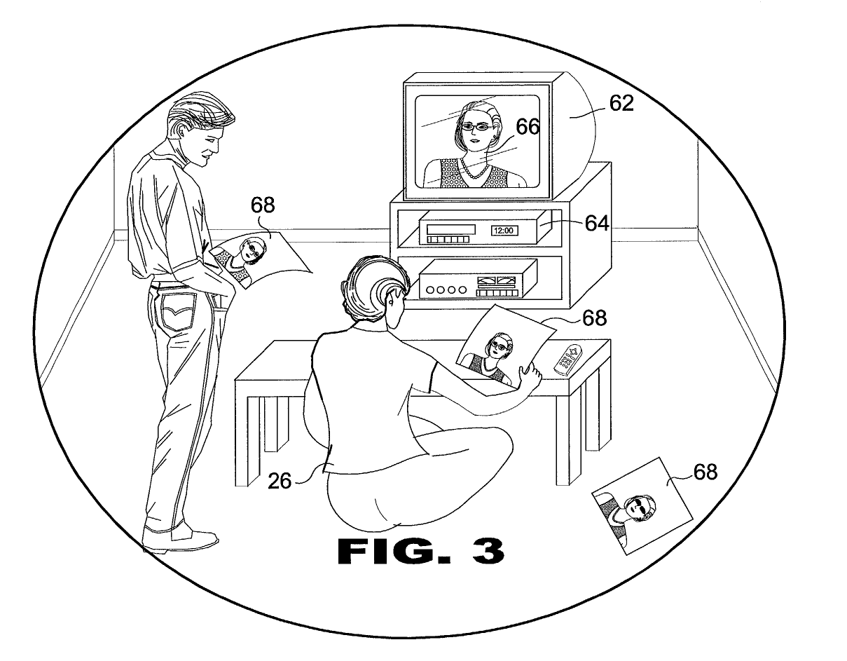

FIG. 3 illustrates the user viewing the image produced by the computerized video imaging device 10. The user 26 is positioned in front of a television monitor 62 having a video reproducing device 64 connected thereto. The user 26 has placed a video tape on which the computerized video imaging device 10 has recorded an image into the video recording device 64. Data stored on the video tape is being reproduced by the video reproducing device 64 and the stored image 66 is displayed on the monitor 62. Also shown in this figure are a plurality of hard copies 68 of images captured by the lens 20 and recorded by the computerized video imaging device 10. Each of the hard copy images 68 are taken from still frames of the recorded video and provide different views of the user. The user 26 is thus able to view the hard copies to see how they appear in different styles and colors of glasses at different angles. The glasses are a computer enhancement which have been added to the image captured by the lens 20 by computer imaging techniques.

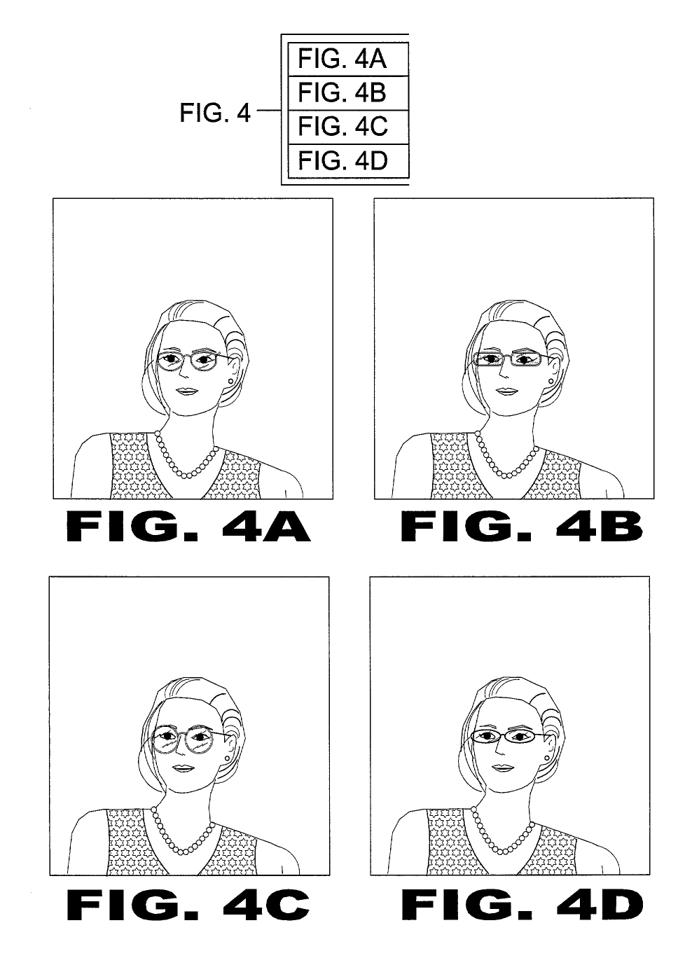

FIGS. 4a-d illustrate a number of computer modifications of a captured image. The computer modifications add different styles of glasses to the captured image to show a user how they appear wearing different types of glass frames without the need to try on each pair of glasses. FIG. 4a illustrates the user wearing a frame which is rounded on its bottom side. FIG. 4b illustrates the user wearing a rectangular shaped frame. FIG. 4c illustrates the user wearing a circular shaped frame and FIG. 4d illustrates the user wearing a frame which is oval in shape. From these figures the user is able to decide on a style of glasses that is determined to look best. It is to be realized that the frames shown in the picture are for purposes of example only. The computerized video imaging device is able to reproduce an image with any number of potential glass frame styles and lenses in any number of colors. The number and colors of frames is only limited by the amount of memory space the computerized video imaging device 10 has and how many different styles and colors can be stored within the memory space.

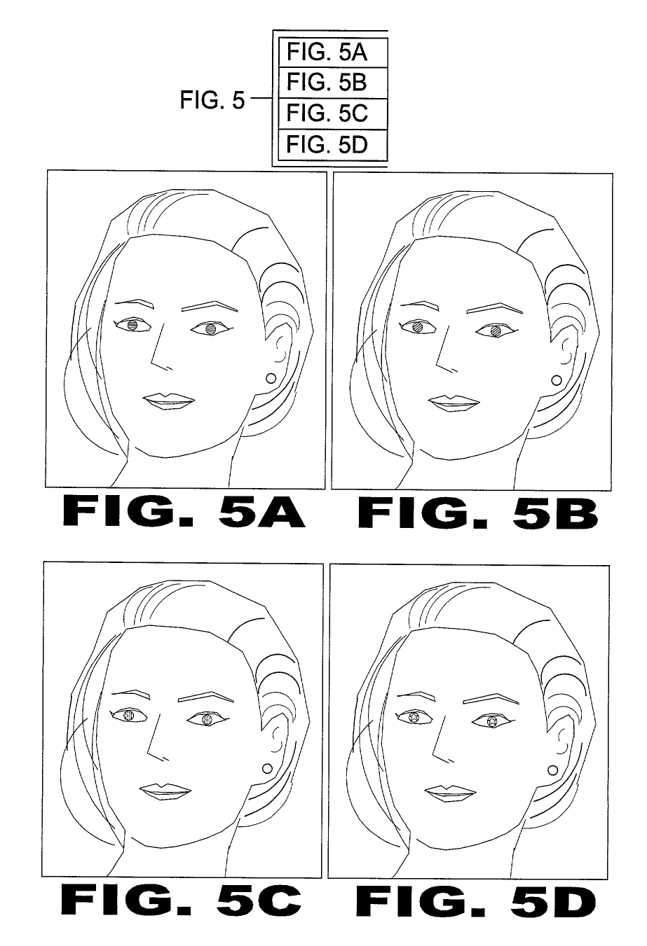

FIGS. 5a-d illustrate a number of computer modifications and enhancements of a captured image to show a user how they would look wearing contact lenses, especially colored contacts or contacts with designs thereon. FIG. 5a illustrates the user wearing a pair of contact lenses having a blue color thereby creating the effect that the user's eyes are blue. FIG. 5b illustrates the user wearing a pair of contact lenses having a green color thereby creating the effect that the user's eyes are green. FIG. 5c illustrates the user wearing a pair of contact lenses having a violet color thereby creating the effect that the user's eyes are violet and FIG. 5d illustrates the user wearing a pair of contact lenses having a star-shaped pattern thereon thereby creating the effect that the user's eyes have a star in the middle of them. From these figures the user is able to decide on a style or color of contact lenses that is determined to look best. It is to be realized that the contact lenses shown in the picture are for purposes of example only. The computerized video imaging device is able to reproduce an image with any number of potential contact lens styles and colors. The number and colors of contact lenses is only limited by the amount of memory space the computerized video imaging device 10 has and how many different styles and colors can be stored within the memory space.

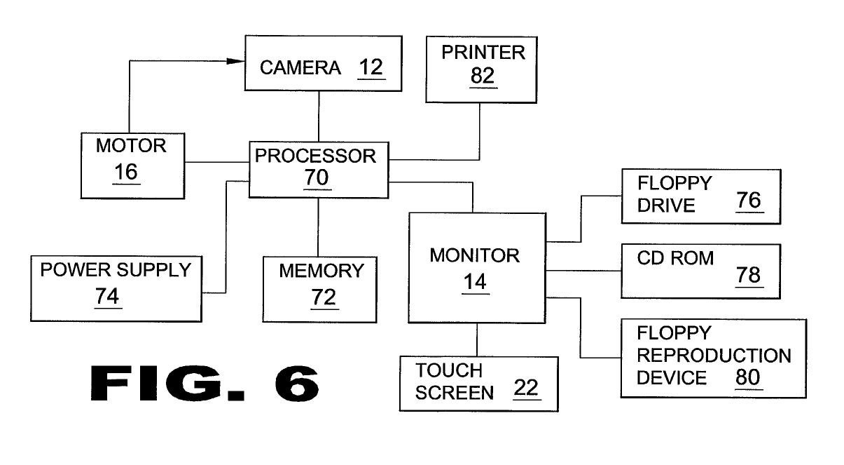

A block diagram of the computerized video imaging device 10 is illustrated in FIG. 6. As can be seen from this figure, the computerized video imaging device 10 includes a processor 70. The processor 70 is connected to a memory unit 72. The memory unit 72 stores all programs which the processor 70 requires to capture, produce an image, alter the image by adding glasses or contact lenses and display the altered image on the video monitor 22. The processor 70 receives power for the computerized video imaging device 10 from a power supply 74. The camera 12 captures images from within the view of the lens and provides the captured images to the processor 70. The motor 16 is connected to both the processor 70 and the camera 12. Under the controls of the processor 70, the motor 16 acts to rotate the camera 12 to thereby capture images at different angles. A printer 82 is also connected to the processor 70 for producing a hard copy of images captured by the camera 12 and displayed on the screen 22 of the monitor 14.

The monitor 14 is connected to the processor 70 for displaying the images captured by the camera 12 as well as the menu list 24 under the control of the processor 70. The floppy drive 76, CD-ROM 78 and video reproducing device 80 are all connected to the monitor 14 for recording images displayed on the monitor 14. The processor 70 is connected to control the operation of the camera 12 based upon the control signals received from the monitor 14 upon contact with icons in the menu list 24 on the screen 22. The processor 70 also controls operation of the motor 16 for rotating the camera 12.

The operation of the computerized video imaging device 10 will now be described with reference to the figures. In operation, the computerized video imaging device 10 is positioned on a stand or table in front of an area in which a user will be positioned. The camera 12 is then loaded with a recording medium on which the image will be recorded. The recording medium can be any or all of a floppy diskette, a compact disk and a video tape. The floppy diskette 43 is inserted through the slot 32 and into the floppy disk drive 76. The compact disk 58 is inserted through the slot 34 and into the compact disk drive 78 drive. The video tape 60 is inserted through the slot 32 and into the video reproducing device 80. The computerized video imaging device 10 is now ready for use.

In use, a person 26 to be filmed is positioned in front of the lens 20 of the camera 12. The person then turns the camera 12, the monitor 14 and the motor on so that they are all operational. At this time, the lens of the camera 12 is able to capture an image of the user 26 and display the image on the screen 22 of the monitor 14. The user 26 then touches the screen 22 at the appropriate position to begin recording of the image captured by the lens 22. Based upon which icon in the menu list 24 the user 26 touches, the corresponding recording device or devices will begin recording. Once recording begins, the motor 16 is controlled by the processor 70 to rotate the camera 12 thus turning the lens 22 and capturing an image of the face of the user at different angles. When the image is captured by the lens 22, it is provided to the processor 70. The processor 70 enhances the captured image and alters the image by adding either glasses or contact lenses to the image in the proper position. The altered image is displayed on the screen 22 for viewing by the user 26. The user 26 is able to change the style, shape and color of the glasses as well as the tint of the lenses by contacting the appropriate icon 24 on the screen 22. The icons 24 on the screen 22 allow the user to change the color of the glasses, change the style of the glasses, change the shape of the glasses, change the tint of the lenses or change the color or style of contact lenses which is added to the image. While the user is changing the style, color and shape of the glasses, the motor 16 causes the camera 12 to continue rotating unless halted by the user using the icons 24 displayed on the touch screen 22. As the camera 12 is rotated, the lens 20 captures images from different angles and thus captures images of different sides of the users head. As the user changes the style, color and shape of the glasses the recording devices are recording images of the user 26 wearing each type of electronically generated glasses. The user 26 is thus able to view themselves in different types of glasses at different angles. The user 26 then stops the recording of the images by pressing the appropriate icon on the touch screen 22. A recording of a complete image of all sides of the user 26 has thus been made as well as recordings of the user's face with all different types of computer generated styles and colors of glasses. The user may continue to alter the style, color and shape of glasses after recording has ceased by displaying a recorded image of the users face on the screen 22 and controlling the processor 70 to add computer generated graphics adding glasses to the image of the face. At this time, the user 26 may create hard copies of particular images at particular angles by activating the printer 82 to print a copy of desired frames from the recording medium.

The user is now able to view the recording of all sides thereof by either removing the recording medium from the computerized video imaging device 10 and placing the recording medium in an appropriate reproducing device. Alternatively, the user may activate the recording devices in the computerized video imaging device 10 to display the recorded images on the screen 22 by contacting the appropriate icon 24 on the screen 22. The user 26 is thus able to see how they look from all angles and on all sides. This is extremely helpful when buying an item such as a pair of glasses. Now the customer can see how the glasses look from all angles. It may also be useful when buying clothes such as a shirt or pants. The customer is now able to see how they look in clothing the wish to purchase prior to purchasing.

From the above description it can be seen that the computerized video imaging device of the present invention is able to overcome the shortcomings of prior art devices by providing a computerized video imaging device which is able to record an image of all sides of a persons head on a recording medium. The computerized video imaging device is able to enhance the image by adding glasses or contact lenses to a proper position on the image thereby providing the user with a depiction of how they look wearing glasses. The computerized video imaging device is also able to alter the frames and lens sizes of the glasses to thereby allow a user to determine what size, shape, style and color glasses best suit them. Furthermore, the computerized video imaging device of the present invention is simple and easy to use and economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the genetic or specific aspects of this invention.

What is claimed is new and desired to be protected by Letters Patent is set forth in the appended claims:

1. A computerized video imaging device for recording an image of all sides of a user, said device comprising:
a) a video camera for capturing an image of the user;
b) means for recording said image captured by said video camera;
c) a monitor for displaying the captured image; and
c) a processor for processing and enhancing the captured image by adding an image of a pair of glasses to the image of the user whereby the altered image is recorded by said recording means and displayed on said monitor whereby the user is able to view themselves in the monitor with a particular style of glasses.

2. The device as recited in claim 1, further comprising a motor for rotating said camera to capture an image of the user at different angles.

3. The device as recited in claim 1, wherein said monitor includes a touch screen and said processor controls display of a plurality of icons on the touch screen for controlling operation of said device by contacting desired ones of said plurality of icons.

4. The device as recited in claim 3, wherein said recording means includes at least one of a floppy disk drive, a CD read/write drive and a video reproducing means.

5. The device as recited in claim 1, further comprising a memory unit, said memory unit storing data representative of a plurality of images of different glasses for use by said processor in altering the image.

6. The device as recited in claim 5, wherein said plurality of images of different glasses represented by the data includes glasses of different styles and shapes.

7. The device as recited in claim 5, wherein said memory unit also stores data representative of a plurality of contact lenses each of said plurality of contact lenses represented by the data having a respective color or design thereon.

8. The device as recited in claim 1, wherein said processor enhances the captured image to thereby alter the image by adding an image of a pair of contact lenses within eyes of the user whereby the altered image is recorded by the recording means and the user is able to view themselves in the monitor with a particular color or designed pair of contact lenses.

9. The device as recited in claim 6, wherein said plurality of icons includes an icon for changing a style of glasses added by said processor.

10. The device as recited in claim 8, wherein said plurality of icons includes an icon for changing a style of contact lenses added by said processor.

11. The device as recited in claim 4, wherein said plurality of icons includes an icon for initiating recording of the image by said floppy disk drive.

12. The device as recited in claim 4, wherein said plurality of icons includes an icon for initiating recording of the image by said CD read/write drive.

13. The device as recited in claim 4, wherein said plurality of icons includes an icon for initiating recording of the image by said video reproducing device.

14. The device as recited in claim 6, wherein said plurality of icons includes an icon for changing a color of said glasses.

15. The device as recited in claim 6, wherein said plurality of icons includes an icon for changing a shape of said glasses.

16. The device as recited in claim 6, wherein said plurality of icons includes an icon for changing a size of said glasses.

17. The device as recited in claim 1, further comprising a printer connected to said processor for generating a hard copy of an image enhanced by said processor.

18. The device as recited in claim 3, wherein said plurality of icons includes an icon for pausing recording of said recording means.

19. The device as recited in claim 3, wherein said plurality of icons includes an icon for freezing display of the image on said monitor.
